(19) United States
(12) Patent Application Publication
(10) Pub. No.: US 2016/0040029 A1
(43) Pub. Date: Feb. 11, 2016

(54) PHOTO-RESPONSIVE HYDROPHILIC COATING

(71) Applicant: EMPIRE TECHNOLOGY DEVELOPMENT LLC, Wilmington, DE (US)

(72) Inventor: Sivaraman RAGHU, Chennai, Tamilnadu (IN)

(73) Assignee: Empire Technology Development LLC

(21) Appl. No.: 14/782,240

(22) PCT Filed: Mar. 18, 2014
(86) PCT No.: PCT/IB2014/059928

§ 371 Date: Oct. 2, 2015

(30) Foreign Application Priority Data
Apr. 2, 2013 (IN) 1490/CHE/2013

(51) Int. Cl. C09D 147/00; B05D 3/06; C08K 3/22

(52) U.S. Cl. CPC C09D 147/00; C08K 3/22; B05D 3/065; C08K 2003/2258; C08K 2003/2296; C08K 2003/2231; C08K 2003/2241

(57) ABSTRACT

Coating compositions that provide hydrophilic and self-cleaning properties upon exposure to UV or visible light are disclosed. Coatings can include derivatives of coumarates and/or azobenzene compounds. When exposed to UV or visible light, these compounds isomerize to cis-configuration which are hydrophilic in nature as compared to when in their hydrophobic trans-state.

### CROSS-REFERENCE TO RELATED APPLICATIONS

This application claims priority from Indian Patent Application Serial No. 1490/CHE/2013, filed Apr. 2, 2013, and titled “PHOTO-RESPONSIVE HYDROPHILIC COATING”, the contents of which are incorporated herein in their entirety.

### BACKGROUND

Surface wettability is one of the paramount properties of solid surfaces and is related closely to practical applications of an object. A surface is said to be wetted if a liquid spreads over the surface evenly without the formation of droplets. Such surfaces tend to be hydrophilic in nature, allowing water to spread out., This implies that the forces associated with the interaction of water with the surface are greater than the cohesive forces associated with bulk liquid water. In contrast, water forms droplets on hydrophobic surfaces, implying that the cohesive forces associated with bulk water are greater than the forces associated with the interaction of water with the surface.

The wettability of a solid surface is commonly determined by contact angle (CA) measurements. For a liquid on a flat surface, the contact angle is considered to be the result of three different types of surface tension at the solid/liquid/gas interface, which is given by Young's equation. Based on Young's equation, hydrophilicity refers to a contact angle less than 90° on solid surfaces, while hydrophobicity refers to a contact angle higher than 90°. If the contact angle is less than 10°, the surface is often designated as super hydrophilic, provided that the surface do not absorb, react or dissolve in the water.

Paints and coatings, while protecting the substrate from the environment, can themselves become covered and contaminated with unwanted substances over time. The appearance of the coated surface of the substrate can often change in undesirable ways. Dirt, for example, can dull the coating by increasing light scattering or by modifying the color component of the coating. Dirt can also affect the coating's durability. It can often be expensive to clean a coated substrate, and detergents, surfactants, fragrances, alkali, lime, and/or other chemicals used to clean a coated substrate can make their way into the environment where they can potentially cause great damage. A hydrophilic surface allows water to spread out in a thin layer, thus sweeping dirt off the surface as the water thins out and trickles away. Thus, it is desirable to have a coating with a hydrophilic surface that prevents dirt from sticking to the surface, is self-cleaning, and is made of environmentally friendly chemicals.

### SUMMARY

The current disclosure describes paints and coatings with hydrophilic and self-cleaning properties. In one embodiment, a coating may comprise a polymer of formula I:

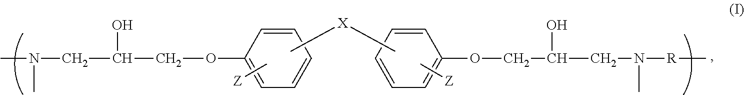

wherein X is —N═N— or —CH═CH—C(═O)—O-(alkylene)-O—C(═O)—CH═CH—; each R is, independently, an alkylene, an arylene, or a bivalent imidazole; and each Z is, independently, H, alkyl, heteroalkyl, aryl, heteroaryl, alkoxy, nitro, cyano, halogen, or cycloalkyl.

In an additional embodiment, a coating may comprise a polymer derived from a monomeric subunit of formula II:

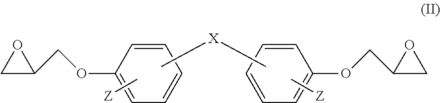

wherein X is —N═N— or —CH═CH—C(═O)—O-(alkylene)-O—C(═O)—CH═CH—; and each Z is, independently, H, alkyl, heteroalkyl, aryl, heteroaryl, alkoxy, nitro, cyano, halogen, or cycloalkyl. The coating may be configured to provide hydrophilic properties, self-cleaning properties, or both when exposed to UV or visible light.

In another embodiment, a method of modifying a hydrophobic surface to a hydrophilic surface comprises applying a coating to the surface, wherein the coating may comprise a polymer of formula (I):

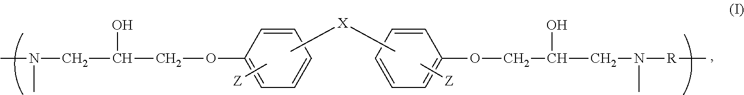

wherein X is —N═N— or —CH═CH—C(═O)—O-(alkylene)-O—C(═O)—CH═CH—; each R is, independently, an alkylene, an arylene, or a bivalent imidazole; each Z is, independently, H, alkyl, heteroalkyl, aryl, heteroaryl, alkoxy, nitro, cyano, halogen, or cycloalkyl; and exposing the coated surface to UV or visible light.

In a further embodiment, a coated article comprises a substrate and a coating on the substrate, wherein the coating may comprise a polymer derived from a monomeric subunit of formula II:

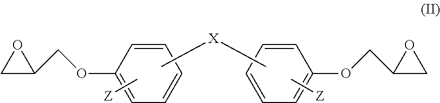

wherein X is —N═N— or —CH═CH—C(═O)—O-(alkylene)-O—C(═O)—CH═CH—; and each Z is, independently, H, alkyl, aryl, alkoxy, nitro, cyano, halogen, or cycloalkyl.

In a further embodiment, a method of preparing a coating may comprise: contacting coumaric acid or derivatives thereof with a diol to form a bis-coumarate compound; contacting the bis-coumarate compound with epichlorohydrin to form a bis-epoxy compound; curing the bis-epoxy compound to form a polymer; and preparing the coating with the polymer.

In an additional embodiment, a method of preparing a coating may comprise: contacting an azobenzene compound with epichlorohydrin to form a bis-epoxy compound; curing the bis-epoxy compound to form a polymer; and preparing the coating with the polymer.

### BRIEF DESCRIPTION OF THE FIGURES

FIG. 1 depicts isomers ofp-coumaric acid and dihydroxy azobenzene according to an embodiment.

FIG. 2 depicts schematics of preparing coumarate bis epoxide according to an embodiment.

FIG. 3 depicts schematics of preparing azobenzene diepoxide according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used herein, “alkylene” refers to refers to a bivalent alkyl moiety having the general formula —(CH₂)ₙ—, where n is from about 1 to about 25, about 1 to about 20, or about 4 to about 20. By bivalent, it is meant that the group has two open sites each of which bonds to another group. Non-limiting examples include methylene, ethylene, trimethylene, pentamethylene, and hexamethylene. Alkylene groups can be substituted or unsubstituted, linear or branched bivalent alkyl groups.

As used herein, “arylene” means a bivalent aryl group that links one group to another group in a molecule. Arylene groups may be substituted or unsubstituted.

As used herein, the term “alkyl” means a saturated hydrocarbon group which is straight-chained or branched. An alkyl group can contain from 1 to 20 carbon atoms, from 2 to 20 carbon atoms, from 1 to 10 carbon atoms, from 2 to 10 carbon atoms, from 1 to 8 carbon atoms, from 2 to 8 carbon atoms, from 1 to 6 carbon atoms, from 2 to 6 carbon atoms, from 1 to 4 carbon atoms, from 2 to 4 carbon atoms, from 1 to 3 carbon atoms, or 2 or 3 carbon atoms. Examples of alkyl groups include, but are not limited to, methyl (Me), ethyl (Et), propyl (e.g., n-propyl and isopropyl), butyl (e.g., n-butyl, t-butyl, isobutyl), pentyl (e.g., n-pentyl, isopentyl, neopentyl), hexyl, isohexyl, heptyl, 4,4 dimethylpentyl, octyl, 2,2,4-trimethylpentyl, nonyl, decyl, undecyl, dodecyl, 2-methyl-1-propyl, 2-methyl-2-propyl, 2-methyl-1-butyl, 3-methyl-1-butyl, 2-methyl-3-butyl, 2-methyl-1-pentyl, 2,2-dimethyl-1-propyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, and the like.

As used herein, the term “alkoxy” means a straight or branched —O-alkyl group of 1 to 20 carbon atoms, including, but not limited to, methoxy, ethoxy, n-propoxy, isopropoxy, t-butoxy, and the like. In some embodiments, the alkoxy chain is 1 to 10 carbon atoms in length, 1 to 8 carbon atoms in length, 1 to 6 carbon atoms in length, 1 to 4 carbon atoms in length, 2 to 10 carbon atoms in length, 2 to 8 carbon atoms in length, f2 to 6 carbon atoms in length, or 2 to 4 carbon atoms in length.

As used herein, the term “aryl” means a monocyclic, bicyclic, or polycyclic (e.g., having 2, 3 or 4 fused rings) aromatic hydrocarbons. In some embodiments, aryl groups have 6 to 20 carbon atoms or 6 to 10 carbon atoms. Examples of aryl groups include, but are not limited to, phenyl, naphthyl, anthracenyl, phenanthrenyl, indanyl, indenyl, tetrahydronaphthyl, and the like. The aryl groups may also be substituted or unsubstituted.

As used herein, the term “cycloalkyl” means non-aromatic cyclic hydrocarbons including cyclized alkyl, alkenyl, and alkynyl groups that contain up to 20 ring-forming carbon atoms. Cycloalkyl groups can include mono- or polycyclic ring systems such as fused ring systems, bridged ring systems, and spiro ring systems. In some embodiments, polycyclic ring systems include 2, 3, or 4 fused rings. A cycloalkyl group can contain 3 to 15 ring-forming carbon atoms, 3 to 10 ring-forming carbon atoms, 3 to 8 ring-forming carbon atoms, 3 to 6 ring-forming carbon atoms, 4 to 6 ring-forming carbon atoms, 3 to 5 ring-forming carbon atoms, or 5 or 6 ring-forming carbon atoms. Ring-forming carbon atoms of a cycloalkyl group can be optionally substituted by oxo or sulfido.

The term “heteroalkyl” refers to alkyl groups in which one or more C atoms are replaced by oxygen, nitrogen, sulfur or combinations thereof.

As used herein, the term “heteroaryl” means an aromatic heterocycle having up to 20 ring-forming atoms (e.g., C) and having at least one heteroatom ring member (ring-forming atom) such as sulfur, oxygen, or nitrogen. In some embodiments, the heteroaryl group has at least one or more heteroatom ring-forming atoms, each of which are, independently, sulfur, oxygen, or nitrogen. In some embodiments, the heteroaryl group has 3 to 20 ring-forming atoms, 3 to 10 ring-forming atoms, 3 to 6 ring-forming atoms, or 3 to 5 ring-forming atoms. In some embodiments, the heteroaryl group contains 2 to 14 carbon atoms, 2 to 7 carbon atoms, or 5 or 6 carbon atoms. In some embodiments, the heteroaryl group has 1 to 4 heteroatoms, 1 to 3 heteroatoms, or 1 or 2 heteroatoms.

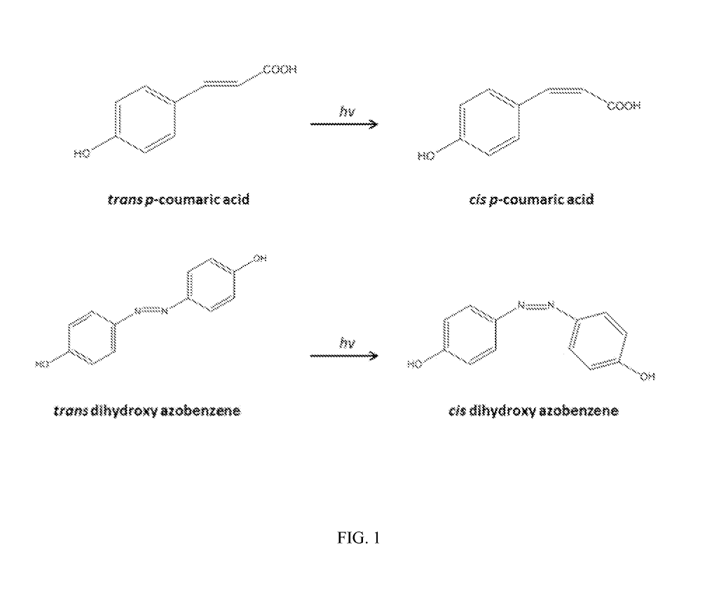

Several organic compounds, such as azobenzenes, spiropyrans, and cinnamates undergo photo-induced reversible trans to cis isomerization upon absorption of energy. These compounds later revert back to their stable trans configuration when the energy is lost. However, these organic compounds display different molecular polarity and surface free energy between these two states. For example, coumarates and azobenzene in their cis-configuration are more hydrophilic than their corresponding trans-state. The present disclosure describes coatings and paints that include coumarate and azobenzene derivatives that acquire cis-configuration when exposed to UV or visible light, and provide hydrophilic and/or self-cleaning properties. FIG. 1 illustrates trans and cis isomers ofp-coumaric acid and dihydroxy azobenzene.

In some embodiments, a coating may include a polymer of formula I:

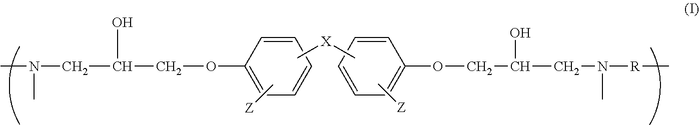

wherein X is —N═N— or —CH═CH—C(═O)—O-(alkylene)-O—C(═O)—CH═CH—; each R is, independently, an alkylene, an arylene, or a bivalent imidazole; and each Z is, independently, H, alkyl, heteroalkyl, aryl, heteroaryl, alkoxy, nitro, cyano, halogen, or cycloalkyl. In some embodiments, X is —CH═CH—C(═O)—O—(CH₂)₂—O—C(═O)—CH═CH—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—(CH₂)₃—; and each Z is, independently, H, alkyl, aryl, alkoxy, nitro, or cyano. In some embodiments, X is —CH═CH—C(═O)—O—(CH₂)₂—O—C(═O)—CH═CH—; each R is, independently, —(CH₂)₂—NH—(CH₂)₂— or —(CH₂)₂—NH—(CH₂)₂—NH—(CH₂)₂—; and each Z is, independently, H, alkyl, aryl, or alkoxy. In some embodiments, X is —N═N—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—CH₂)₃—; and each Z is, independently, H, alkyl, aryl, alkoxy, nitro, or cyano. In some embodiments, X is —N═N—; each R is, independently, —(CH₂)₂—NH—(CH₂)₂— or —(CH₂)₂—NH—(CH₂)₂—NH—(CH₂)₂—; and each Z is, independently, H, alkyl, aryl, or alkoxy. In some embodiments, one or more monomeric subunits of the polymer are present in a cis configuration after exposure to UV or visible light. In some embodiments, one or more monomeric subunits of the polymer may be present as both trans and cis isomers after exposure to UV or visible light.

In some embodiments, a hydrophilic coating may include a polymer derived from a monomeric subunit of formula II:

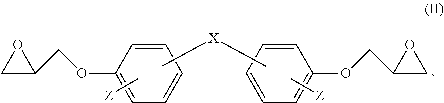

wherein X is —N═N— or —CH═CH—C(═O)—O-(alkylene)-O—C(═O)—CH═CH—; and each Z is, independently, H, alkyl, heteroalkyl, aryl, heteroaryl, alkoxy, nitro, cyano, halogen, or cycloalkyl. In some embodiments, X is —N═N— and each Z is, independently, H, alkyl, aryl, alkoxy, nitro, or cyano. In some embodiments, X is —CH═CH—C(═O)—O-(alkylene)-O—C(═O)—CH═CH—, and each Z is, independently, H, alkyl, aryl, alkoxy, nitro, or cyano. In some embodiments, at least one monomeric subunit may be present in a cis configuration after exposure to UV or visible light. In some embodiments, the monomeric units in the polymers may be present as both trans and cis isomers after exposure to UV or visible light.

Non-limiting examples of the compound of formula II include the following:

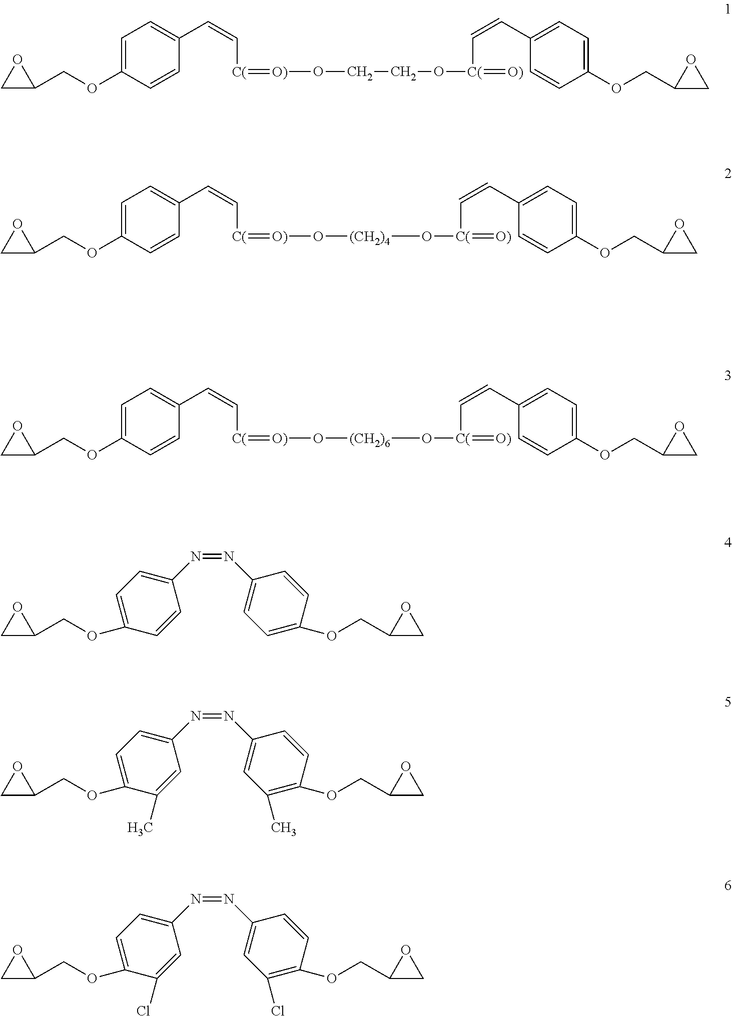

In some embodiments, a method of modifying a hydrophobic surface to a hydrophilic surface may include applying a coating to the surface, wherein the coating includes a polymer of formula (I) or monomers of formula (II), and exposing the coated surface to UV or visible light. Upon exposure to radiation, coumarates and azobenzenes may isomerize to hydrophilic cis-conformations. Due to steric constraints, the polymers of coumarates and azobenzenes may be locked in the hydrophilic cis conformation after irradiation, and may not revert back to the hydrophobic trans-conformation. The cis isomers may be resonance stabilized by formation of relatively stable quinonoid structures, and prevent them from reverting back to trans-configuration.

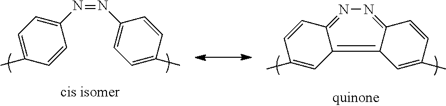

The UV or visible light may have a wavelength of about 300 nanometers to about 700 nanometers, about 300 nanometers to about 600 nanometers, about 300 nanometers to about 500 nanometers, or about 300 nanometers to about 400 nanometers. Specific examples of wavelengths include about 300 nanometers, about 400 nanometers, about 500 nanometers, about 600 nanometers, about 700 nanometers, and ranges between (and including the endpoints of) any two of these values. In some embodiments, a coated surface may be exposed to UV or visible light for about 10 minutes to about 6 hours, for about 10 minutes to about 5 hours, for about 10 minutes to about 4 hours, for about 10 minutes to about 2 hours, or for about 10 minutes to about 1 hour. Specific examples of exposure times include about 10 minutes, about 30 minutes, about 1 hour, about 2 hours, about 3 hours, about 4 hours, about 6 hours, and ranges between (and including the endpoints of) any two of these values.

In additional embodiments, the coating composition may further contain one or more additives. These additives may alter properties of the paint made from the coating composition, such as shelf life, application and longevity, and health and safety. Such additives may be added, for example, during the manufacture of emulsion polymers in the paint or during the formulation of the paint itself. Illustrative additives may include initiators, rheology modifiers, preservatives, and the like. Initiators are a source of free radicals to initiate the polymerization process in which monomers form polymers. Coating compositions may contain a redox system initiator, such as ferrous and thiosulfate along with the persulfate salts, that promote polymerization at room temperature.

In some embodiments, thickeners and rheology modifiers may also be added to coating compositions to achieve desired viscosity and flow properties. Thickeners form multiple hydrogen bonds with the acrylic polymers, thereby causing chain entanglement, looping and/or swelling which results in volume restriction. Thickeners, such as cellulose derivatives including hydroxyethyl cellulose, methyl cellulose and carboxymethyl cellulose, may be used in the coating compositions.

In some embodiments, one or more preservatives may be added in the coating compositions in low doses to protect against the growth of microorganisms. Preservatives, such as methyl benzisothiazolinones, chloromethylisothiazolinones, barium metaborate and 1-(3-chloroallyl)-3,5,7-triaza-1-azoniaadamantane chloride, may be used.

In some embodiments, the coating composition may further contain one or more of the following additives: solvents, pigments, plasticizers, surfactants and the like. Surfactants may be used, for example, to create the micelles for particle formation, as well as long-term particle stabilization. Surfactants may provide stability through electrostatic and steric hindrance mechanisms. Both ionic and non-ionic surfactants may be used. Examples may include, but are not limited to, alkyl phenol ethoxylates, sodium lauryl sulfate, dodecylbenzene sulfonate, polyoxyethylene alkyl ethers, polyoxyethylene alkyl allyl ethers, acetylene glycols, polyoxyethylene, stearic acid and polyoxypropylene.

Coalescing agents, such as ester alcohols, benzoate ethers, glycol ethers, glycol ether esters and n-methyl-2-pyrrolidone, may be added to the coating compositions. Coalescing agents may be added to, for example, insure film formation under varying atmospheric conditions. They may be slow evaporating solvents with some solubility in the polymer phase. They may also act as a temporary plasticizer, allowing film formation at temperatures below the system's glass transition temperature. After film formation, the coalescing agents may slowly diffuse to the surface and evaporate, increasing the hardness and block resistance of the film.

In some embodiments, one or more plasticizers may be added to the compositions to adjust the tensile properties of the paint film. Plasticizers include, for example, a glucose-based derivative, a glycerine-based derivative, propylene glycol, ethylene glycol, phthalates and the like.

A paint, according to the disclosure, may further include one or more pigments. The term “pigments” is intended to embrace, without limitation, pigmentary compounds employed as colorants, including white pigments, as well as ingredients commonly known in the art as “opacifying agents” and “fillers”. Pigments may be any particulate organic or inorganic compound and may provide coatings the ability to obscure a background of contrasting color (hiding power). In some embodiments, the coating may further include photocatalytic pigments, such as titanium dioxide, zinc oxide, tin oxide, tungsten oxide, chromium oxide, hematite, magnetite, wüstite, or any combination thereof. The photocatalytic pigments may be nanoparticles having an average diameter of about 0.1 nanometer to about 100 nanometers. The photocatalytic properties of these pigments may result from the promotion of electrons from the valence band to the conduction band under the influence of ultraviolet (UV) and near-UV radiation. The reactive electron-hole pairs that are created migrate to the surface of these pigment particles where the holes oxidize adsorbed water to produce reactive hydroxyl radicals and the electrons reduce adsorbed oxygen to produce superoxide radicals, both of which can degrade organic compounds and grease sticking to the surface of a coating. In addition to self-cleaning properties, the photocatalytic pigments in paints may also provide hydrophilic properties to a coating. The presence of the photocatalytic pigments along with coumarates and/or azobenzenes may provide a synergistic effect to produce a super hydrophilic coating.

In some embodiments, the coating compositions may include a binder. The binder may be an organic polymeric binder, a silicone polymeric binder, or both. In the broadest aspect, it is contemplated that any polymeric binder may be employed. In some embodiments, the polymeric binder is a water-dispersible polymer. The water-dispersible polymer may include, for example, a polymer or a copolymer of the following: alkylacrylate, alkyl methacrylate, allyl methacrylate, acrylic acid, methacrylic acid, acrylamide, 2-hydroxyethyl methacrylate, 2-hydroxypropyl methacrylate, thioethyl methacrylate, vinyl methacrylate, vinyl benzene, 2-hydroxyethyl acrylate, butyl acrylate, 2-ethylhexyl acrylate, vinyltrimethoxysilane, vinyltriethoxysilane, vinyl formate, vinyl acetate, vinyl propionate, vinyl butyrate, vinyl hexanoate, vinyltoluene, α-methyl styrene, chlorostyrene, styrenesulfonic acid, and combination thereof. Coating compositions may also include a single binder or a mixture of two or more polymeric binders that may be of the same class or different classes. For example, organic binders may be combined with a silicone-based binder. Inorganic binders may include, without limitation, alkali metal polysilicates, such as potassium polysilicate, sodium polysilicate, lithium polysilicate or the like. In some embodiments, the compounds of formula I or II may be cross-linked to the organic binder molecules described herein.

The present disclosure describes hydrophilic coating compositions which when applied to a substrate and cured, results in a hydrophilic coating. A hydrophilic coating composition may be a liquid hydrophilic coating composition, such as a solution or a dispersion including a liquid medium. Any liquid medium that allows application of the hydrophilic coating formulation on a surface may suffice. Examples of liquid media are alcohols, like methanol, ethanol, propanol, butanol or respective isomers and aqueous mixtures thereof, acetone, methylethyl ketone, tetrahydrofuran, dichloromethane, toluene, and aqueous mixtures or emulsions thereof or water. The coating compositions may also be a latex emulsion, non-aqueous dispersion, or powder. The hydrophilic coating composition may further include components that when cured are converted into the hydrophilic coating, and thus remain in the hydrophilic coating after curing. As used herein, curing refers to physical or chemical hardening or solidifying by any method, for example heating, cooling, drying, crystallizing, or curing as a result of a chemical reaction, such as radiation-curing or heat-curing. In the cured state, all or a portion of the components in the hydrophilic coating formulation may be cross-linked forming covalent linkages between all or a portion of the components, for example by using UV or electron beam radiation. In addition, in the cured state, all or a portion of the components may be ionically bonded, bonded by dipole-dipole type interactions, or bonded via Van der Waals forces or hydrogen bonds.

To apply the hydrophilic coating on the substrate, a primer coating may optionally be used in order to promote or provide a binding between the hydrophilic coating and the substrate. In some instances, the primer coating facilitates adhesion of the hydrophilic coating to the substrate. The binding between the primer coating and the hydrophilic coating may occur due to covalent or ionic links, hydrogen bonding, or polymer entanglements. These primer coatings may be solvent-based, water-based (latexes or emulsions) or solvent-free and may include linear, branched and/or cross-linked components. Typical primer coatings that could be used include for example, polyether sulfones, polyurethanes, polyesters, polyacrylates, polyamides, polyethers, polyolefins and copolymers thereof. The hydrophilic coatings can also be applied on the substrate without a primer.

The coatings may be used as a decorative coating, an industrial coating, a protective coating, a UV-protective coating, a self-cleaning coating, a biocidal coating, or any combination thereof. The coatings may generally be applied to any substrate. The coated substrate may be an article, an object, a vehicle or a structure. Although no particular limitation is imposed on the substrate to be used in the present disclosure, exemplary substrates include an exterior of a building, vehicles, bridges, airplanes, metal railings, fences, glasses, plastics, metals, ceramics, wood, stones, cement, fabric, paper, leather, walls, pipes, vessels, medical devices, and the like. The coating may be applied to a substrate by spraying, dipping, rolling, brushing, or any combination thereof.

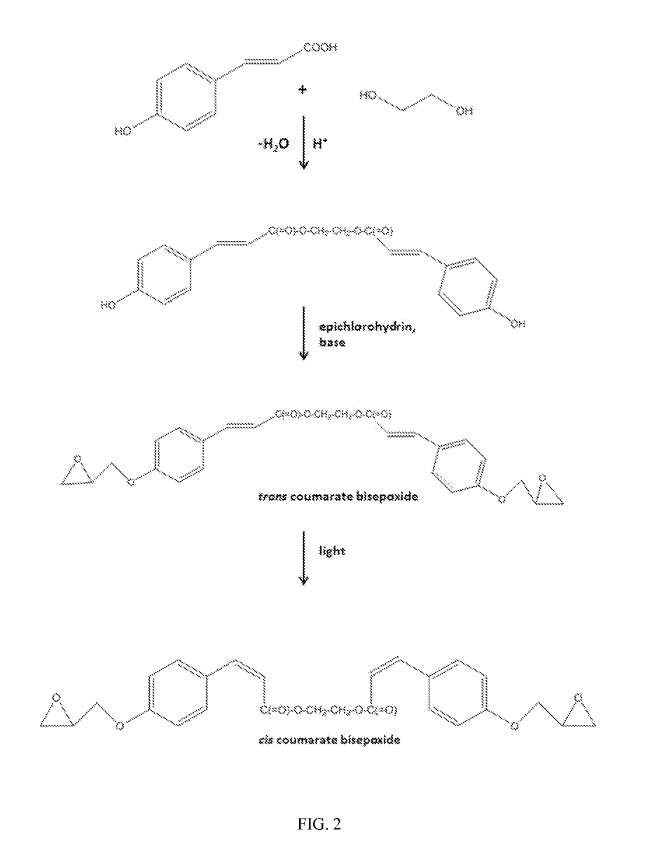

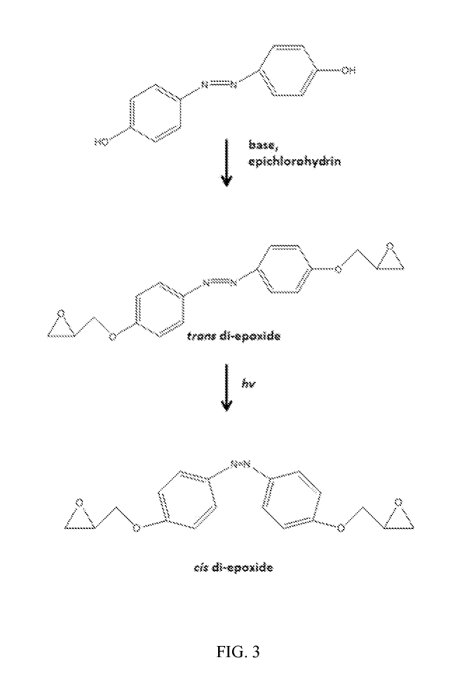

In some embodiments, a method of preparing a coating from coumarates may include: contacting coumaric acid or derivatives thereof with a diol to form a bis-coumarate compound; contacting the bis-coumarate compound with epichlorohydrin to form a bis-epoxy compound; curing the bis-epoxy compound to form a polymer; and preparing the coating with the polymer. The schematics of making cis coumarates and azobenzenes are illustrated in FIGS. 2 and 3.

In some embodiments, a method of preparing a coating from azobenzenes may include: contacting an azobenzene compound with epichlorohydrin to form a bis-epoxy compound; curing the bis-epoxy compound to form a polymer; and preparing the coating with the polymer.

In some embodiments, the coumaric acid or the derivatives thereof and the diol are contacted in a molar ratio of about 1:0.1 to about 1:1, about 1:0.1 to about 1:0.8, about 1:0.1 to about 1:0.5, or about 1:0.1 to about 1:0.2. Specific examples of molar ratios include about 1:0.1, about 1:0.2, about 1:0.5, about 1:0.8, about 1:1, and ranges between (and including the endpoints of) any two of these values.

In some embodiments, the coumaric acid derivatives include alkyl coumarates, such as but not limited to, methyl coumarate, ethyl coumarate, propyl coumarate, butyl coumarate, or any combination thereof. Non-limiting examples of diol include ethylene glycol, diethylene glycol, propane-1,2-diol, propane-1,3-diol, butane-1,2-diol, butane-1,3-diol, butane-1,4-diol, 2-methylpropane-1,2-diol, 2-methylpropane-1,3-diol, pentane-1,2-diol, pentane-1,3-diol, pentane-1,4-diol, pentane-1,5-diol, pentane-2,3-diol, pentane-2,4-diol, 2-methyl-pentane-2,4-diol, hexane-1,2-diol, hexane-1,3-diol, hexane-1,4-diol, hexane-1,5-diol, hexane-1,6-diol, hexane-2,3-diol, hexane-2,4-diol, hexane-2,5-diol, hexane-3,4-diol, heptane-1,2-diol, heptane-1,3-diol, heptane-1,4-diol, heptane-1,5-diol, heptane-1,6-diol, heptane-1,7-diol, heptane-2,3-diol, heptane-2,4-diol, heptane-2,5-diol, heptane-2,6-diol, heptane-3,4-diol, heptane-3,5-diol, octane-1,2-diol, octane-1,3-diol, octane-1,4-diol, octane-1,5-diol, octane-1,6-diol, octane-1,7-diol, octane-1,8-diol, octane-2,3-diol, octane-2,4-diol, octane-2,5-diol, octane-2,6-diol, octane-2,7-diol, octane-3,4-diol, octane-3,5-diol, octane-3,6-diol, octane-4,5-diol, or any combination thereof.

In some embodiments, the coumaric acid or the derivatives thereof and the diol may be heated to a temperature of about 60° C. to 120° C., about 60° C. to 100° C., about 60° C. to 90° C., or about 60° C. to 80° C. Specific examples of temperatures include about 60° C., about 70° C., about 80° C., about 90° C., about 100° C., about 110° C., about 120° C., and ranges between (and including the endpoints of) any two of these values. In some embodiments, a catalyst such as p-toluene sulfonic acid may be included in the reaction process. The coumaric acid or the derivatives thereof and the diol may be heated for about 1 hour to about 4 hours, about 1 hour to about 3 hours, or about 1 hour to about 2 hours. Specific examples of heating times include about 1 hour, about 2 hours, about 3 hours, about 4 hours, and ranges between (and including the endpoints of) any two of these values. At the end of this reaction process, the bis-coumarate compound may be purified by any means known in the art.

In some embodiments, the bis-coumarate compound and the epichlorohydrin may be contacted in a molar ratio of about 1:0.5 to about 1:3, about 1:0.5 to about 1:2, about 1:0.5 to about 1:1.5, or about 1:0.5 to about 1:1. Specific examples of molar ratios include about 1:0.5, about 1:1, about 1:1.5, about 1:2.5, about 1:3, and ranges between (and including the endpoints of) any two of these values. Similarly, the azobenzene compound and the epichlorohydrin may be contacted in a molar ratio of about 1:0.5 to about 1:3, about 1:0.5 to about 1:2, about 1:0.5 to about 1:1.5, or about 1:0.5 to about 1:1. Specific examples of molar ratios include about 1:0.5, about 1:1, about 1:1.5, about 1:2.5, about 1:3, and ranges between (and including the endpoints of) any two of these values. The azobenzene compound may be dihydroxy azobenzene or substituted dihydroxy azobenzene. The substituents on the benzene ring may be, but not limited to, alkyl, aryl, alkoxyl, nitro, cyano, chloro groups, or any combination thereof.

In some embodiments, the bis-coumarate compound, the epichlorohydrin and a basic catalyst are mixed at a temperature of about 0° C. to about 10° C., about 0° C. to about 8° C., about 0° C. to about 6° C., or about 0° C. to about 4° C. Specific examples of mixing temperatures include about 0° C., about 2° C., about 4° C., about 6° C., about 10° C., and ranges between (and including the endpoints of) any two of these values. Similarly, the azobenzene compound, the epichlorohydrin and a basic catalyst are mixed at a temperature of about 0° C. to about 10° C., about 0° C. to about 8° C., about 0° C. to about 6° C., or about 0° C. to about 4° C. Specific examples of mixing temperatures include about 0° C., about 2° C., about 4° C., about 6° C., about 10° C., and ranges between (and including the endpoints of) any two of these values.

The basic catalyst used in the reaction process described herein may be triethylamine, sodium carbonate, potassium carbonate, tributylamine, morpholine, piperidine, or any combination thereof.

The reaction step may further comprise warming the mixture containing the bisepoxides of coumarates or azobenzene to room temperature. The reaction step may further include purifying the bis-epoxy compounds by any methods known in the art.

The bisepoxides formed as described herein may be cured by using any known curing agents, such as an aliphatic amine, an aromatic amine, a polyamide, a secondary amine, a tertiary amine, an imidazole, a polymercaptan, a polysulfide, an anhydride, UV-curing agents, or any combination thereof. Examples of aliphatic amines include ethylene diamine, propylene diamine, hexamethylene diamine, ether diamine, diethylenetriamine, triethylenetetramine, tetraethylenepentamine, diproprenediamine, diethylaminopropylamine, and the like. Examples of aromatic amine include metaphenylene diamine, diaminodiphenylmethane, diaminodiphenyl-sulfone, and the like. Curing may be performed by mixing the bisepoxide compound and the amine, based on a 1:1 molar ratio of number of active hydrogens per epoxy group. The mixture may be allowed to cure at room temperature for several hours to overnight. The curing rate may be enhanced by heating.

### EXAMPLES

### Example 1

### Preparation of Compound 1

Methyl coumarate (17.7 grams, 0.1 mole) and ethylene glycol (3.1 grams, 0.05 mole) are dissolved in 200 ml of toluene. About 1 gram of p-toluene sulfonic acid is added and the mixture was heated to about 90° C. The distillate of toluene-methanol is collected over 2 hours (8 mL). The contents are then washed with a 5% bicarbonate solution, and the toluene is stripped at 50° C. under a slight vacuum. The residue, a waxy solid (16.8 grams, 94%) is analyzed for ethylene 1,2 bis trans-coumarate.

Ethylene 1,2 bis trans-coumarate (17.7 grams, 0.05 mole) dissolved in 200 mL of ethyl acetate is mixed with triethylamine (10 grams, 0.1 mole). The mixture is cooled to 5° C., and epichlorohydrin (9.4 grams, 0.1 mole) is added dropwise while maintaining the temperature between 5° C. and 10° C. After the addition, the mixture is warmed to room temperature and washed with 200 mL water. The organic layer is dried over anhydrous sodium sulfate, and the solvent is removed under reduced pressure. The residue is vacuum dried at room temperature. The viscous oil obtained (22.6 grams, 96%) is analyzed for the bis trans-coumarate epoxide (compound 1). The bis trans-coumarate epoxide is cured by mixing with ethylene diamine.

### Example 2

### Preparation of Compound 2

Methyl coumarate (17.7 grams, 0.1 mole) and butylene 1,4 diol (3.1 grams) are dissolved in 200 ml of toluene. About 1 gram of p-toluene sulfonic acid is added and mixture is heated to about 90° C. The distillate of toluene-methanol is collected over 2 hours (8 mL). The contents are then washed with a 5% bicarbonate solution, and the toluene is stripped at 50° C. under a slight vacuum. The residue, a waxy solid (16.8 grams, 94%) is analyzed for butylene 1,2 bis trans-coumarate.

Butylene 1,2 bis trans-coumarate (17.7 grams) dissolved in 200 mL of ethyl acetate is mixed with triethylamine (10 grams, 0.1 mole). The mixture is cooled to 5° C., and epichlorohydrin (9.4 grams, 0.1 mole) is added dropwise while maintaining the temperature between 5° C. and 10° C. After the addition, the mixture is warmed to room temperature and washed with 200 mL water. The organic layer is dried over anhydrous sodium sulfate, and the solvent is removed under reduced pressure. The residue is vacuum dried at room temperature. The viscous oil obtained (22.6 grams, 96%) is analyzed for the bis trans-coumarate epoxide (compound 2). The bis trans-coumarate epoxide is cured by mixing with ethylene diamine.

### Example 3

### Preparation of Compound 4

Dihydroxy azobenzene (17.7 grams) dissolved in 200 mL of ethyl acetate is mixed with triethylamine (10 grams, 0.1 mole). The mixture is cooled to 5° C., and epichlorohydrin (9.4 grams, 0.1 mole) is added dropwise while maintaining the temperature between 5° C. and 10° C. After the addition, the mixture is warmed to room temperature and washed with 200 mL water. The organic layer is dried over anhydrous sodium sulfate, and the solvent is removed in a rotary evaporator. The residue is vacuum dried at room temperature. The viscous oil obtained (22.6 grams, 96%) is analyzed for the bis trans epoxide (compound 4). The compound is cured by mixing with ethylene diamine.

### Example 4

### Evaluation of Hydrophilic Property

The hydrophilic coating comprising compound 1 is coated on a glass surface and dried at room temperature. The surface is irradiated with UV light for 30 minutes. The surface free energy and the water droplet contact angle of the hydrophilic coating are measured as follows. A Zisman plotting method is employed for measuring the surface free energy. The surface tension of various concentrations of the aqueous solution of magnesium chloride is plotted along the X-axis, and the contact angle in terms of cos θ is plotted along the Y-axis. A graph with a linear relationship between the two is obtained. The graph is extrapolated such that the surface tension at contact angle 0° is measured and is defined as the surface free energy of the solid. The surface free energy of the glass surface measured will be 88 milliNewton/meter.

### Example 5

### An Object Coated with Hydrophilic Paint

A metal table is painted with a hydrophilic coating comprising compound 2 and is allowed to dry at room temperature. The surface is irradiated with UV light for 30 minutes. The surface free energy of the table is measured as explained in Example 4 and will be 85 milliNewton/meter. The anti-fouling property of the coating is measured as follows: A line is drawn on the above mentioned coated table using oily ink. A similar line is also drawn on a table which is coated with an otherwise similar coating without compound 2. An uncoated table is also used in this experiment. A water jet is continuously applied on all three surfaces and periodically checked whether the oily line is still present. The oily ink applied on the table with compound 2 coating will be erased after about 1 minute, whereas the oily line on the un-coated table or on the table lacking compound 2 will be un-changed and visible.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A coating comprising a polymer of formula I: 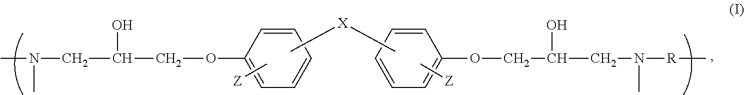
wherein X is —N═N— or —CH═CH—C(═O)—O-(alkylene)-O—C(═O)—CH═CH—;
each R is, independently, an alkylene, an arylene, or a bivalent imidazole; and
each Z is, independently, H, alkyl, heteroalkyl, aryl, heteroaryl, alkoxy, nitro, cyano, halogen, or cycloalkyl.

2. The coating of claim 1, wherein X is —CH═CH—C(═O)—O—(CH₂)₂—O—C(═O)—CH═CH—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—CH₂)₃—; and each Z is, independently, H, alkyl, aryl, alkoxy, nitro, or cyano.

3. The coating of claim 1, wherein X is —N═N—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—CH₂)₃—; and each Z is, independently, H, alkyl, aryl, alkoxy, nitro, or cyano.

4. The coating of claim 1, wherein X is —CH═CH—C(═O)—O—(CH₂)₂—O—C(═O)—CH═CH—; each R is, independently, —(CH₂)₂—NH—(CH₂)₂— or —(CH₂)₂—NH—(CH₂)₂—NH—(CH₂)₂—; and each Z is, independently, H, alkyl, aryl, or alkoxy.

5. The coating of claim 1, wherein X is —N═N—; each R is, independently, —(CH₂)₂—NH—(CH₂)₂— or —(CH₂)₂—NH—(CH₂)₂—NH—(CH₂)₂—; and each Z is, independently, H, alkyl, aryl, or alkoxy.

6. The coating of claim 1, further comprising a solvent, a pigment, a rheology modifier, a plasticizer, or any combination thereof.

7. The coating of claim 1, further comprising a pigment comprising titanium dioxide, zinc oxide, tin oxide, tungsten oxide, or any combination thereof.

8. The coating of claim 1, wherein the coating is a latex emulsion, a non-aqueous dispersion, or a powder.

9. The coating of claim 1, wherein the coating is a decorative coating, an industrial coating, a protective coating, a self-cleaning coating, a biocidal coating, or any combination thereof.

10. The coating of claim 1, wherein the coating is configured to provide hydrophilic properties, self-cleaning properties, or both when exposed to UV or visible light.

11. The coating of claim 10, wherein the UV or visible light has a wavelength of about 300 nanometers to about 700 nanometers.

12. The coating of claim 1, wherein one or more monomeric subunits of the polymer are present in a cis configuration after exposure to UV or visible light.

13.-21. (canceled)

22. A method of modifying a hydrophobic surface to a hydrophilic surface, the method comprising:
applying a coating to the surface, wherein the coating comprises a polymer of formula (I) 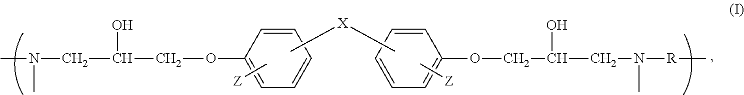
wherein X is —N═N— or —CH═CH—C(═O)—O-(alkylene)-O—C(═O)—CH═CH—,
each R is, independently, an alkylene, an arylene, or a bivalent imidazole,
each Z is, independently, H, alkyl, heteroalkyl, aryl, heteroaryl, alkoxy, nitro, cyano, halogen, or cycloalkyl, and
exposing the coated surface to UV or visible light.

23. The method of claim 22, wherein applying a coating comprises applying a coating comprising the polymer of formula I where X is —CH═CH—C(═O)—O—(CH₂)₂—O—C(═O)—CH═CH—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—CH₂)₃—; and each Z is, independently, H, alkyl, aryl, alkoxy, nitro, or cyano.

24. The method of claim 22, wherein applying a coating comprises applying a coating comprising the polymer of formula I where X is —N═N—; each R is, independently, —CH₂—CH₂—, —(CH₂)₂—NH—(CH₂)₂—, —(CH₂)₂—NH—(CH₂)₂—NH—(CH₂)₂—, or —CH₂—(NH—CH₂)₃—; and each Z is, independently, H, alkyl, aryl, alkoxy, nitro, or cyano.

25. The method of claim 22, wherein applying a coating comprise applying a coating further comprising a solvent, a pigment, a rheology modifier, a plasticizer, or any combination thereof.

26. The method of claim 22, wherein applying a coating comprise applying a coating further comprising a pigment comprising titanium dioxide, zinc oxide, tin oxide, tungsten oxide, or any combination thereof.

27. The method of claim 22, wherein the coating is a latex emulsion, a non-aqueous dispersion, or a powder.

28. The method of claim 22, wherein applying the coating to the surface comprises applying the coating by brushing, spraying, spreading, or rolling on the surface.

29. The method of claim 22, wherein exposing the coated surface to UV or visible light comprises exposing the coated surface to a wavelength of about 300 nanometers to about 700 nanometers.

30. The method of claim 22, wherein exposing the coated surface to UV or visible light comprises exposing for about 10 minutes to about 6 hours.

31.-37. (canceled)

38. A method of preparing a coating, the method comprising:
contacting coumaric acid or derivatives thereof with a diol to form a bis-coumarate compound;
contacting the bis-coumarate compound with epichlorohydrin to form a bis-epoxy compound;
curing the bis-epoxy compound to form a polymer; and
preparing the coating with the polymer.

39. The method of claim 38, wherein the coumaric acid derivatives comprises alkyl coumarates comprising methyl coumarate, ethyl coumarate, propyl coumarate, butyl coumarate, or any combination thereof.

40. The method of claim 38, wherein contacting comprises contacting coumaric acid or derivatives thereof with a diol comprising ethylene glycol, diethylene glycol, propane-1,2-diol, propane-1,3-diol, butane-1,2-diol, butane-1,3-diol, butane-1,4-diol, 2-methylpropane-1,2-diol, 2-methylpropane-1,3-diol, pentane-1,2-diol, pentane-1,3-diol, pentane-1,4-diol, pentane-1,5-diol, pentane-2,3-diol, pentane-2,4-diol, 2-methyl-pentane-2,4-diol, hexane-1,2-diol, hexane-1,3-diol, hexane-1,4-diol, hexane-1,5-diol, hexane-1,6-diol, hexane-2,3-diol, hexane-2,4-diol, hexane-2,5-diol, hexane-3,4-diol, heptane-1,2-diol, heptane-1,3-diol, heptane-1,4-diol, heptane-1,5-diol, heptane-1,6-diol, heptane-1,7-diol, heptane-2,3-diol, heptane-2,4-diol, heptane-2,5-diol, heptane-2,6-diol, heptane-3,4-diol, heptane-3,5-diol, octane-1,2-diol, octane-1,3-diol, octane-1,4-diol, octane-1,5-diol, octane-1,6-diol, octane-1,7-diol, octane-1,8-diol, octane-2,3-diol, octane-2,4-diol, octane-2,5-diol, octane-2,6-diol, octane-2,7-diol, octane-3,4-diol, octane-3,5-diol, octane-3,6-diol, octane-4,5-diol, or any combination thereof.

41. The method of claim 38, wherein contacting the coumaric acid or derivatives thereof with the diol comprises contacting the coumaric acid or the derivatives thereof and the diol in a molar ratio of about 1:0.1 to about 1:1.

42. The method of claim 38, wherein contacting the coumaric acid or derivatives thereof with the diol comprises heating the coumaric acid or the derivatives thereof and the diol to a temperature of about 60° C. to 120° C. in the presence of a catalyst.

43. The method of claim 42, wherein the catalyst is p-toluene sulfonic acid.

44.-45. (canceled)

46. The method of claim 38, wherein contacting the bis-coumarate compound with the epichlorohydrin comprises contacting the bis-coumarate compound and the epichlorohydrin in a molar ratio of about 1:0.5 to about 1:3.

47. The method of claim 38, wherein contacting the bis-coumarate compound with the epichlorohydrin comprises mixing the bis-coumarate compound, the epichlorohydrin and a basic catalyst at a temperature of about 0° C. to about 10° C. to form a mixture.

48. The method of claim 47, wherein the basic catalyst comprises triethylamine, sodium carbonate, potassium carbonate, tributylamine, morpholine, piperidine, or any combination thereof.

49.-50. (canceled)

51. The method of claim 38, wherein curing the bis-epoxy compound comprises curing the bis-epoxy compound with an aliphatic amine, an aromatic amine, a polyamide, a secondary amine, a tertiary amine, an imidazole, a polymercaptan, a polysulfide, an anhydride, UV-curing agents, or any combination thereof.

52.-67. (canceled)
